(19) United States
(12) Patent Application Publication
(10) Pub. No.: US 2018/0117376 A1
(43) Pub. Date: May 3, 2018

(54) METHOD OF EXTINGUISHING OR RETARDING FIRE USING NANO-CLAY

(71) Applicant: KING SAUD UNIVERSITY, Riyadh (SA)

(72) Inventors: REFAT AHMED IBRAHIM EL-SHEIKHY, RIYADH (SA); MOSLEH ALI AL-SHAMRANI, RIYADH (SA)

(21) Appl. No.: 15/343,166

(22) Filed: Nov. 3, 2016

(51) Int. Cl. A62C 13/00; A62D 1/00

(52) U.S. Cl. CPC A62C 13/006; A62D 1/0014

(57) ABSTRACT

A method of extinguishing or retarding fire can include disposing nano-clay onto the fire to retard or extinguish the fire. The nano-clay can be in the form of a powder. The powder can include nanoparticles having a particle size of about 1 nm to about 50 nm. The nano-clay can be used alone or mixed with water.

### BACKGROUND OF THE INVENTION

### 1. Field of the Invention

The present invention relates generally to a fire extinguishing method, and particularly to a method of extinguishing fires using nano-clay as dry powder or in a liquid suspension.

### 2. Description of the Related Art

Methods of fighting and extinguishing fires require fire retardant materials. These types of materials generally include toxic chemicals and/or water. The chemicals typically used for such purposes may be in the form of dry powder or liquids and typically have undesirable side effects not only to the structures or objects that are on fire, but also to human beings in the vicinity and to the surrounding environment.

In the past, chemicals such as potassium carbonate solution, bicarbonate solution with tartaric acid producing CO₂ were used to extinguish fire. In more recent times, other chemicals, such as liquid chlorobromomethane, carbon tetrachloride, chemical foam, Halon-1301, and carbon dioxide under pressure were used to extinguish fires. Some have demonstrated the use of mixtures of ammonium phosphate and barium phosphate to extinguish fire. Others have used polymers, plastics and elastomeric-based materials comprising nano-clays intercalated with protonized silane. Nano-clays have been mixed in small amounts (about 1% to about 5% nano-clay) with polymers as filler to reinforce the polymers and enhance the mechanical properties of the polymers. Additionally, fire extinguishers containing dry gunpowder have been used to extinguish fire.

It would be desirable to use a non-toxic, cost effective, and environmentally friendly material for extinguishing fires.

Thus, a method of extinguishing fire solving the aforementioned problems is desired.

### SUMMARY OF THE INVENTION

A method of extinguishing or retarding fire can include disposing nano-clay onto the fire for retarding or extinguishing the fire. The nano-clay can include particles having a particle size of about 1 nm to about 50 nm. The nano-clay can be in powder form or in a suspension including water.

The nano-clay can be stored in and dispensed from any suitable container, such as a conventional fire extinguisher vessel or a spray bottle.

These and other features of the present invention will become readily apparent upon further review of the following specification and drawings.

### BRIEF DESCRIPTION OF THE DRAWINGS

FIGS. 1A-D show the nano-clay dry powder agglomerated in particles having a maximum size of about 15-20 microns in resolutions of (A) 100 microns (B) 5 microns (C) 3 microns and (D) 1 micron respectively.

FIG. 2 is a plot of the elemental composition of the nano-clay.

### DETAILED DESCRIPTION OF THE PREFERRED EMBODIMENTS

A method of extinguishing or retarding fire includes disposing nano-clay onto the fire to extinguish or retard the fire. The nano-clay can be obtained from natural or synthetic sources. The nano-clay can include nanoparticles of layered, mineral silicates, as is generally known in the art. The nano-clay can be a nano-clay powder. The nano-clay can be disposed onto the fire in powder form. Alternatively, the nano-clay can be mixed with water and the nano-clay can be disposed onto the fire in a liquid suspension. In yet another alternative, a quantity of nano-clay powder can be melted and disposed onto the fire as a liquid.

The present inventors have found that nano-clay alone or mixed with water alone is more effective than using only water for extinguishing or retarding fires. Further, nano-clay is more advantageous than other chemical fire extinguishing materials as nano-clay does not chemically react with the materials on which it is dispersed. Nano-clay is a natural or green, light-weight material, with no deleterious side effects when used as a fire extinguisher. It is inexpensive and available in large quantities all over the world. Nano-clay does not have toxic effects on human health or the environment.

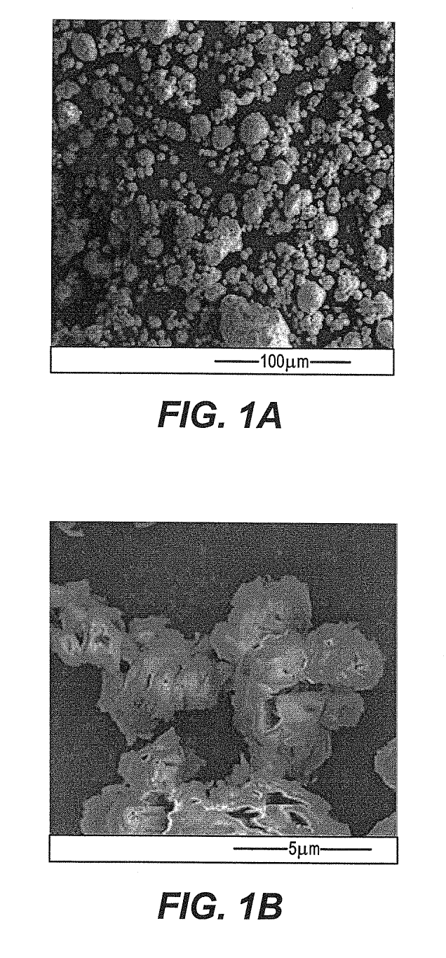

The nano-clay can be in the form of a very fine powder. The powder can include nanoparticles having a particle size between 1-50 nm, preferably 10-20 nm. The powder can be white, red, yellow, green or grey. FIGS. 1A-1D show nano-clay dry powder agglomerated in particles displaying a maximum size of about 15-20 microns in resolutions of (A) 100 microns (B) 5 microns (C) 3 microns and (D) 1 micron respectively.

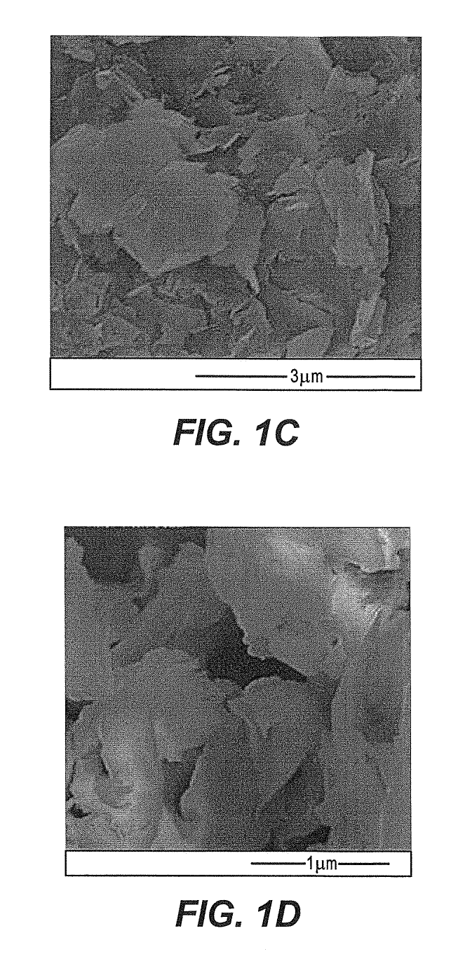

The nano-clay can include mainly silicate aluminum. For example, the nano-clay can include aluminum, silica, and optionally, a very small ratio of one or more other minerals, including Ca, Mg, Na, K, and Fe. The nano-clay can include any type of nano-clay, including, montimorillonite clay, bentonite clay, kaoelinite clay, hectorite clay, and halloysite clay. The nano-clay has high thermal resistance properties, is fire resistant, hydrophilic, and has high mechanical properties. FIG. 2 shows the plot of the elemental composition of a type of nano-clay that can be used in the present methods. Table 1 shows the elemental composition of the nano-clay.

TABLE 1
Elemental Composition of natural nano-clay

| Element | Weight % |
|---|---|
| O | 48.31 |
| Mg | 3.76 |
| Al | 10.15 |
| Si | 30.57 |
| K | 2.64 |
| Ca | 1.00 |
| Fe | 3.57 |

The nano-clay can be stored as a powder in a container, such as a hand-held cylindrical pressure vessel or conventional fire extinguisher, and dispensed therefrom when needed to extinguish a fire. The pressurized container can include a mixture of the nano-clay and a delivery gas. The delivery gas can include at least one of nitrogen, carbon dioxide, and air. The vessel can be operated to disperse the nano-clay particles in a continuous stream or spray towards a fire or burning object. Alternatively, the nano-clay powder can be mixed with water and stored as a suspension in a vessel. The vessel can be a pressurized vessel as described above or a vessel with a manually operated pump mechanism that includes a pump attached to a tube in the bottle for drawing liquid therethrough, such as a spray bottle. The spray bottle can be further configured to include a fan or other mixing device which can be operated to mix the nano-clay with the water in the bottle prior to dispensing. Dispensing the liquid from the bottle can include clenching a trigger on the spray bottle and spraying the suspension including the nano-clay through a nozzle or hose of the bottle.

Vessels or containers including the nano-clay or nano-clay suspension can be loaded onto a vehicle, such as a car, truck, airplane or helicopter. The nano-clay can be used to extinguish any type of fire, including an open flame or a smoldering fire from burning material such as a forest fire or fire due to warfare.

It is to be understood that the present invention is not limited to the embodiments described above, but encompasses any and all embodiments within the scope of the following claims.

1. A method of extinguishing or retarding fire, comprising:
obtaining a quantity of powdered montmorillonite-based nano-clay, the montmorillonite-based nano-clay including nanoparticles having a particle size of about 1 mm to about 50 nm;
storing the powdered montmorillonite-based nano-clay in a container; and
dispensing the powdered montmorillonite based nano-clay from the container onto said fire for retarding or extinguishing the fire.

2. The method of extinguishing or retarding fire according to claim 1, wherein the nano-clay nanoparticles have a particle size of about 10 run to about 20 nm.

3. (canceled)

4. The method of extinguishing or retarding fire according to claim 1, wherein the container is a pressurized vessel, the pressurized vessel including the nano-clay powder and a delivery gas.

5. The method of extinguishing or retarding fire according to claim 4, wherein the delivery gas is selected from the group consisting of nitrogen, carbon dioxide, air, or a combination thereof.

6. The method of extinguishing or retarding fire according to claim 1, further comprising mixing the nano-clay powder with water to form a suspension, and storing the suspension in the container.

7. The method of extinguishing or retarding fire according to claim 6, wherein the container is a pressurized container including the suspension and a delivery gas.

8. The method of extinguishing or retarding fire according to claim 7, wherein the delivery gas is selected from the group consisting of nitrogen, carbon dioxide, air, or a combination thereof.

9.-10. (canceled)

11. A method of extinguishing or retarding fire, comprising:
obtaining a quantity of powdered nano-clay, the nano-clay including nanoparticles having a particle size of about 1 nm to about 50 nm;
storing the powdered nano-clay in a container, wherein the powdered nano-clay is the sole component therein; and
dispensing the powdered nano-clay from the container onto the fire for retarding or extinguishing the fire.
